(19) United States
(12) Patent Application Publication
(10) Pub. No.: US 2025/0291397 A1
(43) Pub. Date: Sep. 18, 2025

(54) POWER CONTROL DEVICE

(71) Applicant: ASUSTeK COMPUTER INC., Taipei (TW)

(72) Inventor: Jian-Hui LEE, Taipei (TW)

(21) Appl. No.: 19/058,305

(22) Filed: Feb. 20, 2025

(30) Foreign Application Priority Data
Mar. 15, 2024 (CN) 202410296604.9

(51) Int. Cl. G06F 1/28

(52) U.S. Cl. CPC G06F 1/28

(57) ABSTRACT

A power control device, electrically connected to a power supply device which provides power to a power receiving device. The power control device comprises: a connection port, electrically connected to the power supply device; a power controller, electrically connected to the connection port and the power receiving device, the power controller supply the power to the power receiving device via the connection port; a detector, electrically connected to the connection port to detect the power and generate a power supply signal correspondingly; and the processor, electrically connected to the power controller and the detector, the processor compares the power supply signal and the preset threshold to select a preset upper limit or dynamically set an upper usage limit, the processor generates a control signal to the power controller and the power controller controls a function parameter of the power receiving device according to the control signal.

### CROSS-REFERENCE TO RELATED APPLICATION

This application claims the priority benefit of CN application No. 202410296604.9, filed on Mar. 15, 2024. The entirety of the above-mentioned patent application is hereby incorporated by references herein and made a part of specification.

### BACKGROUND OF THE INVENTION

### Field of the Invention

The disclosure relates to a power control device that controls a power usage of a power receiving device.

### Description of the Related Art

Power for current light bars is usually provided via a Universal Serial Bus (USB). A light bar can be illuminated when it is connected to a USB connection port of the computer device, a USB charger or a portable source. However, the power of various power supply devices such as computer devices, USB chargers or portable sources is different. When power consumption of the light bar in use is greater than the power provide by the power supply device, the power supply device and the light bar may have power failure or even be damaged if the power of the light bar is not controlled.

### BRIEF SUMMARY OF THE INVENTION

A power control device adapted to be electrically connected to a power supply device is provided. The power supply device provides power to a power receiving device, the power control device comprises: a connection port, electrically connected to the power supply device; a power controller, electrically connected to the connection port and the power receiving device, the power controller provides the power to the power receiving device via the connection port; a detector, electrically connected to the connection port to detect the power and generate a power supply signal correspondingly; and a processor, electrically connected to the power controller and the detector, the processor compares the power supply signal and a preset threshold to select a preset upper limit or dynamically set an upper usage limit, the preset upper limit is higher than the upper usage limit, the processor generates a control signal to the power controller base on the preset upper limit or the upper usage limit, and the power controller controls a function parameter of the power receiving device according to the control signal.

In sum, a power control device is provided in embodiments of the invention. The power control device can directly detect the power supply signal of the voltage, current or power of the power supply device. Cooperating with a processor, the power supply signal is calculated and determined. The power of the power receiving device (such as a light bar, a USB screen or a USB fan) is controlled via the power controller. As a result, when the user adjusts the function parameter of the power receiving device, power outages or damages to the power supply device and the power receiving device can be avoided.

These and other features, aspects and advantages of the present invention will become better understood with regard to the following description, appended claims, and accompanying drawings.

### BRIEF DESCRIPTION OF THE DRAWINGS

FIG. 1 is a block diagram of a power control device according to an embodiment of the application;

FIG. 2 is a flow chart of a power control device in operation according to an embodiment of the application; and

FIG. 3 is a block diagram of a power control device according to another embodiment of the application.

### DETAILED DESCRIPTION OF THE EMBODIMENTS

The embodiments of this application will be described below with the diagrams. In addition, some components or structures are not shown in figures to clearly show other features of this application. In these diagrams, the same reference numerals indicate the same or similar components or circuits.

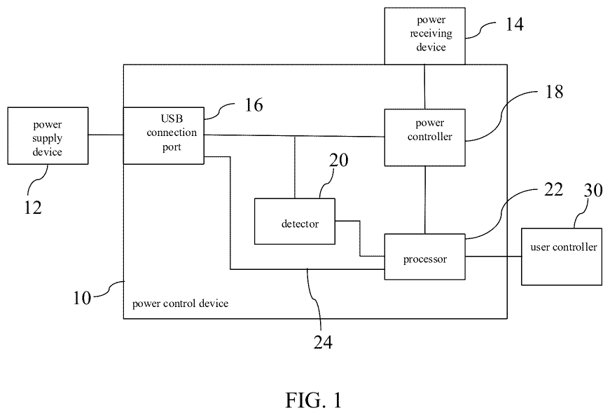

As shown in FIG. 1, a power control device 10 is electrically connected to a power supply device 12. The power supply device 12 provides power to a power receiving device 14. The power control device 10 includes a connection port, a power controller 18, a detector 20, and a processor 22. In the embodiment, the connection port is a USB connection port 16.

As shown in FIG. 1, in the power control device 10, the USB connection port 16 is electrically connected to the power supply device 12 to allow the power supply device 12 to provide power to the power control device 10 via the USB connection port 16. A terminal of the power controller 18 is electrically connected to the USB connection port 16, and another terminal of the power controller 18 is electrically connected to the power receiving device 14. The power controller 18 controls the supply of the power, and the power is provided to the power receiving device 14 via the USB connection port 16. The detector 20 is electrically connected to the USB connection port 16 to detect the power from the USB connection port 16, and a power supply signal is generated according to the power. In the embodiment, when the detector 20 is a voltage detector, the power supply signal is a voltage signal. When the detector 20 is a current detector, the power supply signal is a current signal. When the detector 20 is a power detector, the power supply signal is a power signal. A terminal of the processor 22 is electrically connected to the power controller 18, and another terminal of the processor 22 is electrically connected to the detector 20. The processor 22 is electrically connected to the USB connection port 16 to transmit data via a data transmission line 24. When the processor 22 receives the power supply signal from the detector 20, the processor 22 compares the power supply signal and a preset threshold to select to use a preset upper limit or dynamically set an upper usage limit. The preset upper limit is higher than the upper usage limit. For example, when the preset upper limit is 100%, the upper usage limit is 80%, which is not limited herein. After the comparison between the power supply signal and the preset threshold, the processor 22 generates a control signal to the power controller 18 base on the preset upper limit or the upper usage limit. The power controller 18 controls a function parameter of the power receiving device 14 according to the control signal to make the function parameter be adjusted in a range not larger than the preset upper limit or in the range not larger than the upper usage limit.

The processor 22 compares the power supply signal and the preset threshold. If the power supply signal does not reach the preset threshold, the preset upper limit is selected. The power controller 18 controls the function parameter of the power receiving device 14 to be adjusted in the range not larger than the preset upper limit according to the control signal. If the power supply signal reaches the preset threshold, the upper usage limit is selected to replace the preset upper limit. The power controller 18 controls the function parameter of the power receiving device 14 to be adjusted in the range not larger than the upper usage limit according to the control signal. A value of the function parameter is adjusted to the upper usage limit at most.

In an embodiment, as shown in FIG. 1, the processor 22 is further electrically connected to a user controller 30. The user controller 30 is adapted to adjust the function parameter of the power receiving device 14 in the range not larger than the preset upper limit or in the range not larger than the upper usage limit. In embodiments, the user controller 30 is a computer, a mobile phone, a button, a knob or a remote controller, which is not limited herein.

In an embodiment, the power supply signal is a voltage signal, and the detector 20 is a current detector. When the processor 22 receives the current signal, the current signal is calculated and converted into a voltage value for comparison. Similarly, if the detector 20 is a power detector, when the processor 22 receives the power signal, the power signal is calculated and converted into a voltage value for subsequent comparison.

As shown in FIG. 1, when the power receiving device 14 is power on, the processor 22 loads a previous upper usage limit before a last shutdown of the power receiving device 14. The processor 22 gradually increases the function parameter of the power receiving device 14 from zero to the previous upper usage limit, and compares the power supply signal and the preset threshold. If the power supply signal during this period does not reach the preset threshold, the processor 22 automatically adjusts a setting value of the power receiving device 14 to the previous upper usage limit. If the power supply signal reaches the preset threshold before the functional parameter is adjusted to the previous upper usage limit, the processor 22 sets the setting value corresponding to the functional parameter at this moment as an upper usage limit value, and the value of the function parameter of the power receiving device 14 is able to be adjusted to the setting value at most.

In the embodiment, when the power receiving device 14 is a light bar or a USB screen, the function parameter is a brightness parameter to adjust a brightness of the light bar or the USB screen. When the power receiving device 14 is a USB fan, the function parameter is an intensity parameter to adjust a rotation intensity of the USB fan.

In an embodiment, the processor 22 is one or a combination of a Central Processing Unit (CPU), a Microcontroller Unit (MCU), a Microprocessor, a digital signal processor (DSP), an Application-specific Integrated Circuit (ASIC), and a System on a Chip (SOC), which is not limited herein.

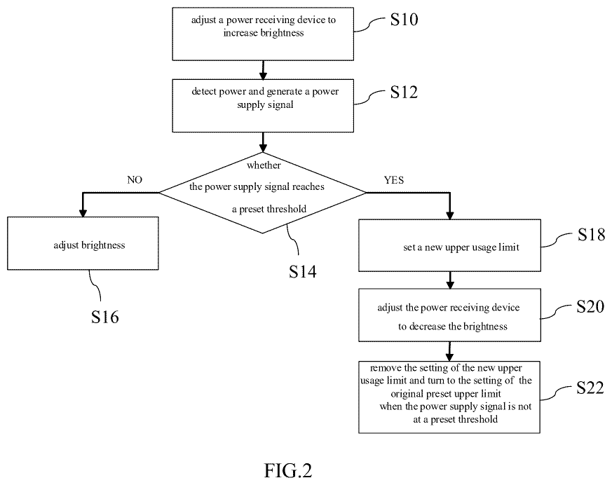

As shown in FIG. 1 and FIG. 2, in the embodiment, the power receiving device 14 is a light bar. As shown in step S10, the power receiving device 14 (the light bar) is operated to increase the brightness. As shown in step S12, the detector 20 detects the power, generates and transmits a corresponding power supply signal to the processor 22. As shown in step S14, the processor 22 determines whether the power supply signal reaches the preset threshold. When the power supply signal does not reach the preset threshold, as shown in step S16, the brightness is adjusted, and the function parameter (the brightness parameter) is adjusted to the required brightness. When the power supply signal reaches the preset threshold, as shown in step S18, the setting value corresponding to the power that the power supply device 12 is able to provide at the time is set as a new upper usage limit. The power controller 18 controls the function parameter of the power receiving device 14 to be adjusted in the range not larger than the new upper usage limit according to the control signal. Then, as shown in step S20, the brightness of the power receiving device 14 (the light bar) is adjusted to make the brightness (the function parameter) in the range not larger than the new upper usage limit. The value of the function parameter is able to be adjusted to the new upper usage limit at most. Finally, as shown in step S22, since the detector 20 continuously detects the change of the power of the power supply device 12, when the processor 22 determines that the power supply signal is not at the preset threshold, the processor 22 removes the setting of the new upper usage limit and turns to the setting of the original preset upper limit of the power receiving device 14.

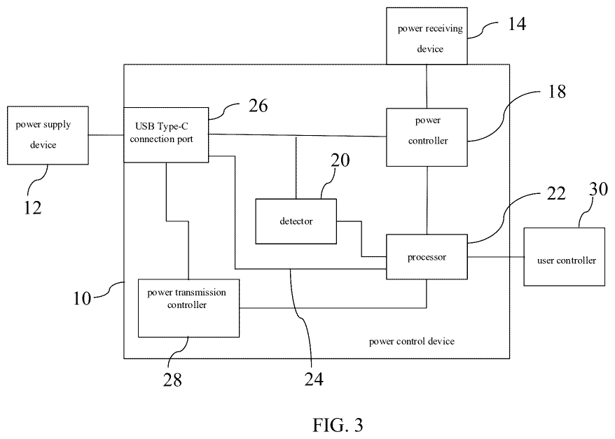

As shown in FIG. 3, the power control device 10 includes a connection port, a power controller 18, a detector 20, a processor 22, and a power transmission controller 28. In the embodiment, the connection port is USB Type-C connection port 26. In the power control device 10, the USB Type-C connection port 26 is electrically connected to the power supply device 12 to provide the power from the power supply device 12 to the power control device 10 via the USB Type-C connection port 26. A terminal of the power controller 18 is electrically connected to the USB Type-C connection port 26, and another terminal of the power controller 18 is electrically connected to the power receiving device 14. The power controller 18 controls the supply of the power. The power is provided to the power receiving device 14 via the USB Type-C connection port 26 and the power controller 18. The detector 20 is electrically connected to the USB Type-C connection port 26 to detect the power input from the USB Type-C connection port 26 and generate the power supply signal correspondingly. A terminal of the processor 22 is electrically connected to the power controller 18, another terminal of the processor 22 is electrically connected to the detector 20. The processor 22 is further electrically connected to the USB Type-C connection port 26 via a data transmission line 24 to have data transmission. A terminal of the power transmission controller 28 is electrically connected to the USB Type-C connection port 26, the other terminal of the power transmission controller 28 is electrically connected to the processor 22. The power transmission controller 28 generates the preset threshold correspondingly according to transmission handshake information. When the processor 22 receives the power supply signal detected from the detector 20, the processor 22 compares the power supply signal and the preset threshold to select a preset upper limit or dynamically set an upper usage limit. The preset upper limit is higher than the upper usage limit. When the power supply signal does not reach the preset threshold, the processor 22 selects the preset upper limit and generates the control signal to the power controller 18 according to the preset upper limit. The power controller 18 controls the function parameter of the power receiving device 14 to be adjusted in the range not larger than the preset upper limit according to the control signal. When the power supply signal reaches the preset threshold, the processor 22 selects to set the upper usage limit, and the upper usage limit replaces the preset upper limit. The control signal is generated to the power controller 18 base on the upper usage limit, and the power controller 18 controls the function parameter of the power receiving device 14 to be used in the range not larger than the upper usage limit according to the control signal. The value of the function parameter is adjusted to the upper usage limit at most.

In the embodiment, as shown in FIG. 3, the processor 22 is electrically connected to the user controller 30 to allow users to adjust the function parameter of the power receiving device 14 in the range not larger than the preset upper limit or in the range not larger than the upper usage limit via the user controller 30.

In the embodiment, a level comparison table (not shown) is built in the processor 22. When the preset threshold is received, the processor 22 generates the upper usage limit according to the preset threshold and the level comparison table. In embodiment, the level comparison table is a brightness comparison table. Power consumption and brightness levels of the preset threshold are shown in Table 1. The processor 22 looks up the corresponding brightness level according to the power consumption of the preset threshold and the brightness comparison table, and the corresponding brightness level is regarded as the upper usage limit.

TABLE 1

| Brightness level (%) | Power consumption (W) |
|---|---|
| 10 | 0.9 |
| 20 | 1.3 |
| 30 | 1.6 |
| 40 | 1.9 |
| 50 | 2.3 |
| 60 | 2.7 |
| 70 | 3.1 |
| 80 | 3.5 |
| 90 | 3.8 |
| 100 | 4.3 |

As shown in FIG. 3, when the power receiving device 14 is power on, the processor 22 calculates the require power of the power supply device 12 according to the transmission handshake information. Then, the processor 22 loads a previous upper usage limit before a last shutdown of the power receiving device. If the power setting corresponding to the previous upper usage limit is in the range not larger than the power that the power supply device 12 is able to provide, the previous upper usage limit is set as the new upper usage limit, and the function parameter is automatically adjusted to the previous upper usage limit. When the power setting corresponding to the previous upper usage limit exceeds the power range, the upper usage limit is adjusted to the setting value corresponding to the power that the power supply device 12 is able to provide to be regarded as the new upper usage limit. The function parameter is adjusted corresponding to the new upper usage limit instead of the previous upper usage limit.

As shown in FIG. 2 and FIG. 3, When the steps for adjusting the brightness of the power receiving device 14 (the light bar) is via the power control device 10 are the same as the process shown in FIG. 2, which is not described again for a concise purpose.

In the embodiment, as shown in FIG. 1 and FIG. 3, the power supply device 12 is a computer device. The computer device provides the power to the power receiving device 14 via the power control device 10. Application software is built in the computer device. In an embodiment, the application software is used to adjust the function parameter of the power receiving device 14. The processor 22 transmits data relating to the adjustment of the function parameter to the computer device via the USB connection port 16 or the USB Type-C connection port 26, and the function parameter is adjusted through the application software. Furthermore, the processor 22 transmits the current preset upper limit or the upper usage limit to the application software, and the adjustable range of the function parameter is controlled via the application software.

In sum, a power control device is provided in embodiments of the invention. The power control device can directly detect the power supply signal of the voltage, current or power of the power supply device. Cooperating with a processor, the power supply signal is calculated and determined. The power of the power receiving device (such as a light bar, a USB screen or a USB fan) is controlled via the power controller. As a result, when the user adjusts the function parameter of the power receiving device, power outages or damages to the power supply device and the power receiving device can be avoided.

Although the present invention has been described in considerable detail with reference to certain preferred embodiments thereof, the disclosure is not for limiting the scope of the invention. Persons having ordinary skill in the art may make various modifications and changes without departing from the scope. Therefore, the scope of the appended claims should not be limited to the description of the preferred embodiments described above.

What is claimed is:

1. A power control device, adapted to be electrically connected to a power supply device, the power supply device provides power to a power receiving device, the power control device comprising:
a connection port, electrically connected to the power supply device;
a power controller, electrically connected to the connection port and the power receiving device, the power controller provides the power to the power receiving device via the connection port;
a detector, electrically connected to the connection port to detect the power and generate a power supply signal correspondingly; and
a processor, electrically connected to the power controller and the detector, the processor compares the power supply signal and a preset threshold to select to use a preset upper limit or dynamically set an upper usage limit, the preset upper limit is higher than the upper usage limit, the processor generates a control signal to the power controller base on the preset upper limit or the upper usage limit, and the power controller controls a function parameter of the power receiving device according to the control signal.

2. The power control device according to claim 1, wherein when the power supply signal does not reach the preset threshold, the preset upper limit is selected, and the power controller controls the function parameter of the power receiving device to be adjusted in a range not larger than the preset upper limit according to the control signal; when the power supply signal reaches the preset threshold, the upper usage limit is selected to set, and the power controller controls the function parameter of the power receiving device to be adjusted in the range not larger than the upper usage limit according to the control signal.

3. The power control device according to claim 2, wherein when the power receiving device is power on, the processor loads a previous upper usage limit before a last shutdown of the power receiving device, and gradually increases the functional parameter of the power receiving device from zero to the previous upper usage limit, if the power supply signal during this period does not reach the preset threshold, the processor automatically adjusts a setting value of the power receiving device to the previous upper usage limit; and if the power supply signal reaches the preset threshold before the functional parameter is adjusted to the previous upper usage limit, the setting value corresponding to the functional parameters when the power supply signal reaches the preset threshold is set as the upper usage limit value.

4. The power control device according to claim 2, wherein the connection port is a USB connection port.

5. The power control device according to claim 4, wherein when the power receiving device is a light bar or a USB screen, the function parameter is a brightness parameter, and when the power receiving device is a USB fan, the function parameter is an intensity parameter.

6. The power control device according to claim 2, wherein the connection port is a USB Type-C connection port.

7. The power control device according to claim 6, further comprising a power transmission controller electrically connected to the USB Type-C connection port and the processor, and the power transmission controller generates the preset threshold according to the transmission handshake information.

8. The power control device according to claim 7, wherein a level comparison table is built in the processor, when the processor receives the preset threshold, the processor generates the upper usage limit correspondingly according to the preset threshold and the level comparison table.

9. The power control device according to claim 8, wherein when the power receiving device is power on, the processor calculates power that the power supply device is able to provide according to the transmission handshake information, after the processor loads a previous upper usage limit before the last shutdown of the power receiving device, when a power setting corresponding to the previous upper usage limit is in the range not larger than the power that the power supply device is able to provide, the previous upper usage limit is set as the upper usage limit, when the power setting corresponding to the previous upper usage limit is out the range of the power that the power supply device is able to provide, the upper usage limit is adjusted to the setting value corresponding to the power that the power supply device is able to provide.

10. The power control device according to claim 6, wherein when the power receiving device is a light bar or a USB screen, the function parameter is a brightness parameter, and when the power receiving device is a USB fan, the function parameter is an intensity parameter.

11. The power control device according to claim 1, further comprising a data transmission line electrically connected to the connection port and the processor.

12. The power control device according to claim 1, wherein the detector is a voltage detector, and the power supply signal is a voltage signal.

13. The power control device according to claim 1, wherein the detector is a current detector, and the power supply signal is a current signal.

14. The power control device according to claim 1, wherein the detector is a power detector, and the power supply signal is a power signal.

15. The power control device according to claim 1, wherein the power supply device is a computer device, the function parameter of the power receiving device is adjusted via application software built in the computer device, the processor transmits relating data to the computer device via the connection port to adjust the function parameter through the application software, the processor transmits a current preset upper limit or the upper usage limit to the application software, and the adjustable range of the function parameter is controlled via the application software.

16. The power control device according to claim 2, further comprising a user controller electrically connected to the processor, the function parameter of the power receiving device is adjusted in the range not larger than the preset upper limit or in the range not larger than the upper usage limit via the user controller.
